(19) United States
(12) Patent Application Publication
(10) Pub. No.: US 2008/0228504 A1
(43) Pub. Date: Sep. 18, 2008

(54) Technique to Deflect Incident Ticket Submission in Real-Time

(76) Inventors: Binh Q. Nguyen, Cary, NC (US); Gregg Robertshaw, Raleigh, NC (US); Kurtis F. Martin, Durham, NC (US)

Correspondence Address: HAMILTON & TERRILE, LLP;IBM RSW, P.O. BOX 203518, AUSTIN, TX, 78720, US

(21) Appl. No.: 11/685,274

(22) Filed: Mar. 13, 2007

(51) Int. Cl. G06Q 10/00

(52) U.S. Cl. 705/1

(57) ABSTRACT

A method, system and computer-usable medium are disclosed for reducing the amount of human interaction involved in the resolution of incident tickets. A user interacts with a self-service portal to generate an incident ticket to resolve an issue. The generated incident ticket is routed by the self-service portal to an incident ticket management system for processing. The incident ticket management system accepts the incident ticket and in turn routes it to an incident ticket deflection system (ITDS). The ITDS analyzes the resolution state of the issue and generates relevant search queries that are submitted to an issue resolution knowledgebase. The results of the search queries are then returned to the ITDS, which compares them to captured interactions of the user with the self-service portal. Irrelevant query results or those that match the captured user interactions are disregarded. The remaining query results are used by the ITDS to generate remedial actions for the user to perform. If the remedial actions do not resolve the user's issue, then the incident ticket is escalated to a helpdesk operator. When received by the helpdesk operator, the incident ticket is populated with the captured user interactions with the self-service portal, the recommended remedial actions for the user to perform, and the current resolution status of the user's issue. The helpdesk operator then uses the information contained in the escalated incident ticket to facilitate the resolution of the user's issue.

### BACKGROUND OF THE INVENTION

1. Field of the Invention

The present invention relates in general to the field of computers and similar technologies, and in particular to software utilized in this field. Still more particularly, it relates to a method, system and computer-usable medium for the resolution of incident tickets.

2. Description of the Related Art

Today's businesses are constantly striving to attain higher levels of customer approval and satisfaction. At the same time, they are attempting to increase the efficiency and effectiveness of their customer care systems while simultaneously lowering their customer service costs. These seemingly conflicting goals have resulted in three closely related industry trends. First, more and more responsibility for customer support is being shifted to the customer, often through Internet access to a customer self-service portal. Second, the development and implementation of sophisticated customer relationship management (CRM) systems is now allowing customer support personnel to achieve a more comprehensive view of customer interactions. Third, technical and product support staffs are being reduced in attempt to constrain labor costs.

The widespread availability of the Internet as an access channel, the advent of integrated knowledgebases, and the emergence of innovative and comprehensive search capabilities has made customer access to a wealth of technical and product information a reality. As a result, more and more customers are discovering they prefer interacting with a self-service portal to lengthy call waiting delays and protracted verbal exchanges with one or more service representatives to resolve their issues. Furthermore, the number of support calls is reduced and the company saves whenever the customer answers their own questions or solves their own problems. However, due to inconsistencies in the abilities and operation of self-service portals, customers can experience irritation when they are unable to find the information they need in the form they need it. When this occurs, there is a risk that the customer will become frustrated and feel alienated instead of rewarded and satisfied. The net result is there are times when human interaction is required and the customer's issue needs to be escalated to helpdesk support.

Operation of a helpdesk is labor intensive and therefore expensive. Consequently, automation of helpdesk problem resolution has become a key objective for customer service providers. Typical helpdesk systems use computerized files commonly referred to as incident tickets that summarize the customer's issues. Once opened, the incident ticket tracks and documents the series of electronic or verbal exchanges between the customer and the helpdesk operator(s) leading to resolution of the issue. These incident tickets are either opened by the customer at the self-service portal, or by an operator when the customer makes the first call to the helpdesk, and they are subsequently closed when all documented user issues are finally resolved. They may comprise a single issue and resolution pair, or they may span multiple issues, questions, symptoms, responses, attempted fixes, and resolutions, all pertaining to the same basic issue. Some helpdesk systems use free-form incident tickets consisting primarily of short text descriptions while others use more sophisticated, forms-based approaches. Either of these may include workflow automation to route the incident ticket to the most suitable resource or to escalate the issue to more knowledgeable or specialized operators. Regardless of their implementation, the incident ticket is accessed by each helpdesk operator in the escalation chain to review prior resolution efforts and exchanges with the customer. However, current helpdesk systems do not allow the pre-population of incident tickets with a history of the customer's previous interaction with the self-service portal prior to the creation of an incident ticket. The lack of this history requires the helpdesk operator to manually ascertain, document and review the customer's personal efforts to resolve their issue, which can be time consuming and tedious. As a result, the helpdesk operator's time is not used efficiently and many of the supposed gains of a self-service portal are offset.

### BRIEF SUMMARY OF THE INVENTION

The present invention includes, but is not limited to, a method, system and computer-usable medium for reducing the amount of human interaction involved in the resolution of incident tickets. In selected embodiments, a user with an unresolved issue interacts with a self-service portal to generate an incident ticket to resolve the issue. In one embodiment, a user populates an on-line incident ticket form with their user information and the details of the unresolved issue. The user then submits the incident ticket form to the self-service portal, which routes the incident ticket to an incident ticket management system for processing. The incident ticket management system accepts the incident ticket and in turn routes it to an incident ticket deflection system (ITDS). The ITDS analyzes the current state of the issue contained in incident ticket and generates relevant search queries to an issue resolution knowledgebase.

The results of the search queries are then returned to the ITDS and compared to the captured interactions of the user with the self-service portal. These captured interactions include, but are not limited to, search queries the user submitted to the issue resolution knowledgebase, the returned results of the search queries, and the associated knowledgebase content presented to the user. The ITDS compares these captured user interactions to its previously returned query results and disregards those that either match or are not relevant to the unresolved user issue. The remaining relevant, non-matching knowledgebase query results are then analyzed by the ITDS to determine their applicability to resolving the user's issue. In one embodiment, an algorithm is implemented to rank the applicability of the remaining knowledgebase query results to resolving the user's issue. In another embodiment, a predetermined confidence threshold value is applied to the algorithm to limit the number of remaining knowledgebase query results that are a possible means of resolving the user's issue.

The ITDS uses the remaining knowledgebase query results to generate remedial actions for the user to perform. If the remedial actions resolve the user's issue, then the incident ticket is closed. If not, the user is given the option to escalate the incident ticket to a human helpdesk operator for resolution. The escalation may or may not require a telephone call. A self-service portal may provide instant messaging (IM) or voice over IP (such as Skype) that the user can interact with the help desk personnel. In one embodiment, the ITDS may require the user to perform the remedial actions before helpdesk contact information is provided. In another embodiment, the user escalates the incident ticket by placing a telephone call to a helpdesk operator. The helpdesk operator accepts the phone call and requests predetermined information to confirm the user's identity and to locate their associated incident ticket. Once located, the incident ticket is retrieved from the incident ticket management system and is presented to the helpdesk operator. When presented, the incident ticket is populated with all relevant user interactions with the self-service portal, recommended remedial actions presented to the user, and the current resolution status of the user's issue. The helpdesk operator then uses the information contained in the escalated incident ticket to facilitate the resolution of the user's issue. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a block diagram of an embodiment of an incident ticket deflection system; and

FIG. 3 shows a flow chart of the operation of an embodiment of an incident ticket deflection system.

### DETAILED DESCRIPTION

The present invention provides a method, system and computer-usable medium for reducing the amount of human interaction involved in the resolution of incident tickets. In selected embodiments, a user with an unresolved issue interacts with a self-service portal to generate an incident ticket to resolve the issue. The incident ticket is submitted to the self-service portal, which routes it to an incident ticket management system for processing. The incident ticket management system accepts the incident ticket and in turn routes it to an incident ticket deflection system (ITDS). The ITDS analyzes the current state of the issue contained in incident ticket and generates relevant search queries that are submitted to an issue resolution knowledgebase. The results of the search queries are then returned to the ITDS, which compares them to captured interactions of the user with the self-service portal. Returned query results that are either irrelevant or match the captured user interactions are disregarded. The ITDS uses the remaining relevant, non-matching knowledgebase query results to generate remedial actions for the user to perform. If the remedial actions do not resolve the user's issue, then the incident ticket is escalated to a helpdesk operator. When the helpdesk operator retrieves the incident ticket, it is populated with the captured user interactions with the self-service portal, recommended remedial actions presented to the user, and the current resolution status of the user's issue. The helpdesk operator then uses the information contained in the escalated incident ticket to facilitate the resolution of the user's issue.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

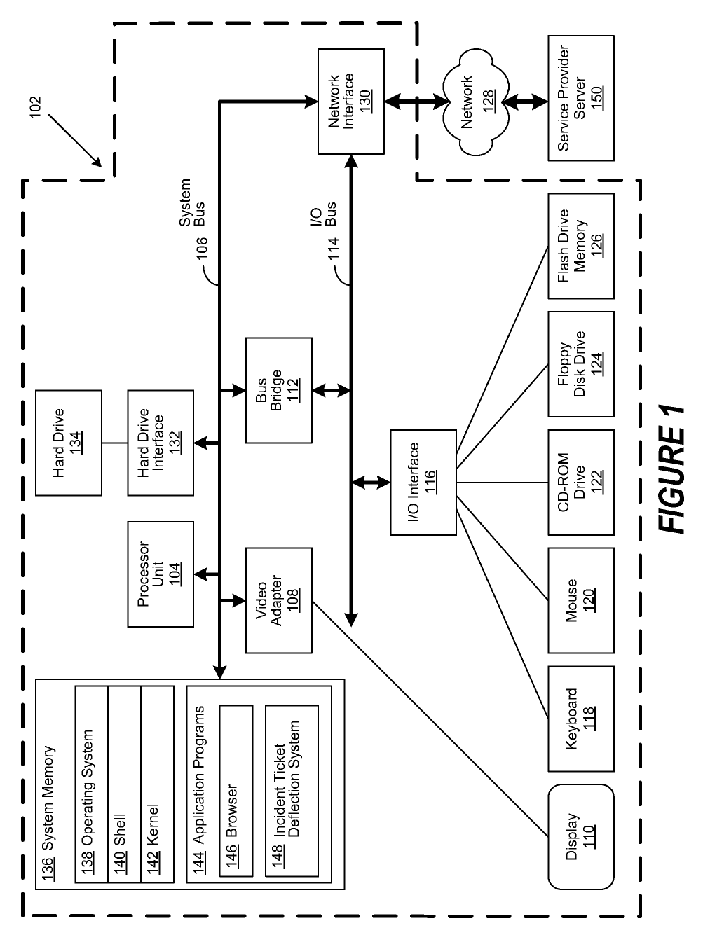

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

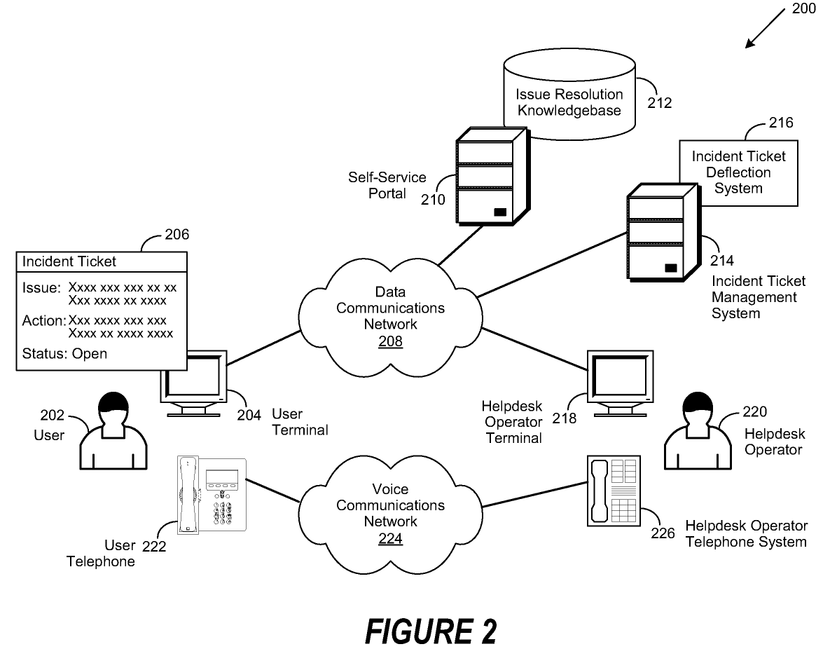

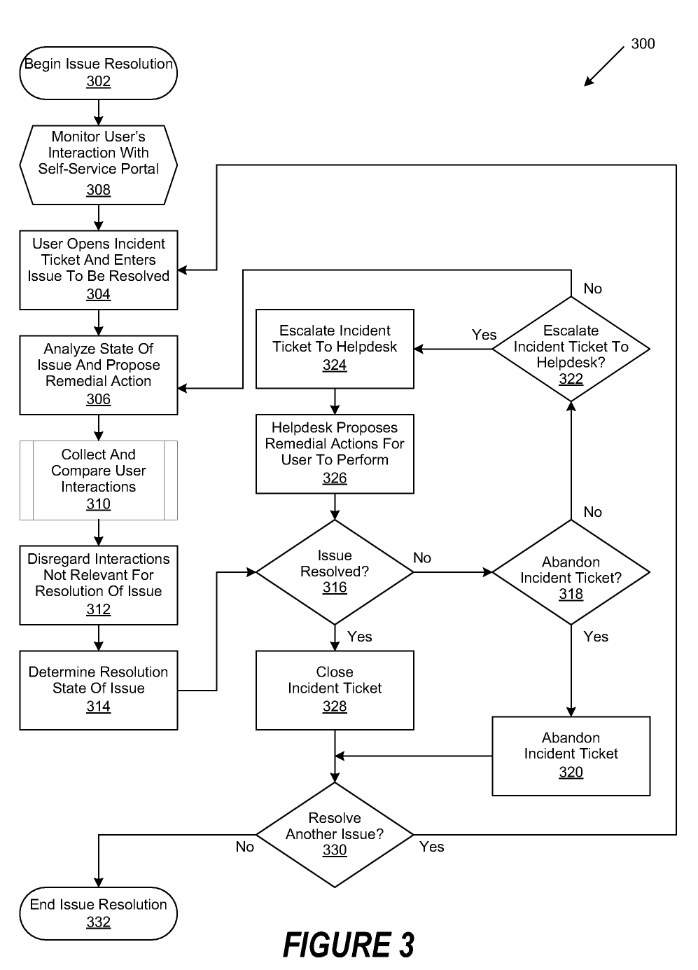

Application programs 144 may include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 150. Application programs 144 also includes an incident ticket deflection system 148. Incident ticket deflection system 148 includes code for implementing the processes described in FIGS. 2-3 described herein below. In one embodiment, client computer 102 is able to download the incident ticket deflection system 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a block diagram of an incident ticket deflection system 200 as implemented in accordance with an embodiment of the invention. In selected embodiments, a user 202 with an unresolved issue uses terminal 204 to accesses the self-service portal 210 through data communications network 208. Once the user 202 has accessed the self-service portal 210 an on-line incident ticket form is presented on the user terminal 204. The user populates the on-line incident ticket form with user information and the unresolved issue and then submits the completed form to the self-service portal 210 for processing as an incident ticket.

Once submitted, the self-service portal 210 routes the submitted incident ticket 206 through the data communications network 208 to the incident ticket management system 214. The incident ticket management system 214 then uses the incident ticket deflection system (ITDS) 216 to analyze the current state of the unresolved issue and to propose remedial actions to the user 202. To generate the remedial actions, the ITDS 216 uses the contents of the submitted incident ticket 206 to generate relevant knowledgebase queries, which are passed back to the incident ticket management system 214. The incident ticket management system routes the knowledgebase queries through the data communications network 208 and then submits them to the self-service portal 210. The self-service portal 210 in turn submits the relevant knowledgebase queries to the issue resolution knowledgebase 212, which returns the results of the knowledgebase queries. The path is retraced through the self-service portal 210, the data communications network 208, and the incident ticket management system 214 to provide the results of the relevant knowledgebase queries to the ITDS 216.

The ITDS 216 then queries the self-service portal 210 for any past interactions with the user 202 that it may have captured. These past interactions include, but are not limited to, search phrases and terms the user 202 submitted as search queries to the issue resolution knowledgebase 212, the returned results of the submitted search queries, and the associated knowledgebase content presented to the user 202. In one embodiment, the user 202 has a userID that allows the self-service portal 210 to monitor and record all user interactions with the self-service portal 210 and the issue resolution knowledgebase 212. In another embodiment, the user 202 is required to establish a user identity that allows the monitoring and recording of their interactions with the self-service portal 210 and the issue resolution knowledgebase 212. In yet another embodiment, the user 202 is uniquely identifiable through the use of predetermined factors, such as a static IP address, that allows the self-service portal 210 to monitor and record the user's interactions with the self-service portal 210 and the issue resolution knowledgebase 212. If these monitored interactions have been captured, they are returned by the self-service portal 210 through the data communications network 208 to the incident ticket management system 214, which then presents them to the ITDS 216. If past interactions with the self-service portal 210 with the user 202 have not been monitored, captured, then the ITDS 216 instructs the self-service portal 210 to begin doing so. In one embodiment, the captured user interactions are referenced to a unique incident ticket 206 number. In another embodiment, the captured user interactions are referenced to other predetermined information, such as the userID of the user 202.

If the previous interactions of the user 202 with the self-service portal 210 and the issue resolution knowledgebase 212 are available, the ITDS 216 performs comparison operations between the captured interactions and the previously returned results of the relevant knowledgebase queries. Captured user interactions that are not relevant to the unresolved issue are then disregarded. For example, the user 202 may have had one previous interaction where they queried the self-service portal 210 regarding the scheduling of an upcoming product demonstration. Afterwards, they may have then queried the self-service portal 210 regarding the operational specifications of a certain function of the same product. Subsequent to receiving the product specifications, they may have had an interaction with the self-service portal 210 to attempt to self-resolve a product issue by submitting a query to the issue resolution knowledgebase 212. In this example, the interaction inquiring about upcoming product demonstration dates would not be considered relevant to the resolution of the user's issue and would be disregarded by the ITDS 216. However, the interaction inquiring about the operational specifications of the product may have relevance if the operational specifications inquiry were about the same product referenced in the incident ticket 206. Similarly, any interactions the user 202 had with the issue resolution knowledgebase 212 attempting to self-resolve the same issue contained in the incident ticket 206 would be considered relevant by the ITDS 216.

Once the ITDS 216 discards previously captured user interactions that are considered irrelevant, it performs further comparison operations between the remaining captured interactions and the previously returned results of the relevant knowledgebase queries. Those remaining captured user interactions that match the previously returned results of the relevant knowledgebase queries are signified as such by the ITDS 216. The non-matching knowledgebase query results are then analyzed by the ITDS 216 to determine their applicability to resolving the user issue contained in incident ticket 206. In one embodiment, an algorithm is implemented by the ITDS 216 to rank the applicability of the non-matching knowledgebase query results to resolving the user issue contained in incident ticket 206. In another embodiment, a predetermined confidence threshold value is applied to the algorithm to limit the number of non-matching knowledgebase query results that are presented to the user 202 as a possible means of resolving the user issue contained in incident ticket 206. In this embodiment, the non-matching knowledgebase query results that are above the predetermined confidence threshold are presented by the ITDS system 216 to the user 202 as a possible means of resolving the user issue contained in incident ticket 206. The user 202 is presented these means of resolving their issue through the user terminal 204 as one or more recommended remedial actions contained in the incident ticket 206.

The user 202 has the option of performing the recommended remedial actions, abandoning the incident ticket 206, or escalating the incident ticket 206 to a helpdesk operator 220. If the user 202 decides to perform the recommended remedial actions, then they are performed and the results are entered into the user terminal 204, conveyed through data communications network 208, and submitted to the self-service portal 210. Once the self-service terminal receives the results, they are routed through data communications network 208 to the incident ticket management system 214, which in turn routes them to the ITDS 216 for processing. The ITDS 216 then performs further comparison and analysis operations as described in greater detail hereinabove to determine the resolution state of the issue contained in incident ticket 206, and if required, generate further recommended remedial actions. These remedial actions are then routed back to the user, using the processes and routing described in greater detail hereinabove, for presentation through the user terminal 204 to the user 202. The process continues until the user 202 signifies to the self-service portal 210 that their issue has been resolved and the incident ticket 206 is closed, or that they have decided to abandon resolution of the issue contained in the incident ticket 206.

If the user decides not to perform the recommended remedial actions, then the self-service portal 210 gives the user 202 the option of escalating the incident ticket 206 to a helpdesk operator 220. In one embodiment, the ITDS 216 may require the user 202 to perform the recommended remedial action before helpdesk contact information is provided allowing the user to escalate the incident ticket 206 to a helpdesk operator 220. If the user 202 decides to escalate the incident ticket 206, the user telephone 222 is used to place a call to the helpdesk operator telephone system 226 through the voice communications network 224. Once the helpdesk operator 220 accepts the phone call, predetermined information is requested from the user 202 to determine and confirm their identity and to locate their associated incident ticket 206. Once located, the incident ticket 206 is retrieved from the incident ticket management system 214 and it is then presented to the helpdesk operator 220 on the helpdesk operator terminal 218. Prior to its presentation, the ITDS 216 populates the incident ticket 206 with all relevant user interactions with the self-service portal 210, recommended remedial actions presented to the user 202, and the current resolution status of the user's issue. The helpdesk operator 220 then uses the information contained in the escalated incident ticket 206 to resolve the user's issue. It will be apparent to those of skill in the art that provision of this information on the incident ticket 206 offers the advantage of reducing the amount of time required by the helpdesk operator 220 to determine what previous efforts have been made to resolve the user's issue. Furthermore, it will be similarly appreciated that this time reduction enables more effective responses to the needs of the user 202 and more cost-effective use of the helpdesk operator 220.

FIG. 3 shows a flow chart depicting the operation of an incident ticket deflection system 300 as implemented in accordance with an embodiment of the invention. In selected embodiments, issue resolution begins in step 302 with a user accessing a self-service portal where an incident ticket is presented as an on-line form in step 304. The user populates the on-line incident ticket form in step 304 with their user information and the details of the unresolved issue. The user then submits the incident ticket to the self-service portal, which routes the incident ticket to an incident ticket management system (not illustrated) for processing. The incident ticket management system accepts the incident ticket and in turn routes it to an incident ticket deflection system (ITDS), which in step 306 analyzes the current state of the issue contained in incident ticket and generates remedial actions that are proposed to the user.

In one embodiment, the ITDS generates proposed remedial actions by using the contents of the submitted incident ticket to generate relevant search queries to an issue resolution knowledgebase. The results of the relevant search queries are then returned to the ITDS. The ITDS then queries the self-service portal for any past interactions with the user it may have captured. The past interactions include, but are not limited to, search phrases and terms the user submitted as search queries to the issue resolution knowledgebase, the returned results of the submitted search queries, and the associated knowledgebase content presented to the user. If these monitored interactions have been captured, they are returned by the self-service portal to the ITDS. If past interactions with the self-service portal with the user have not been monitored, captured, then the ITDS instructs the self-service portal to begin doing so in step 308.

Captured interactions of the user with the self-service portal and the issue resolution knowledgebase are collected in step 310 where they are used by the ITDS to perform comparison operations against the previously returned results of the relevant knowledgebase queries. Captured user interactions that are not relevant to the unresolved issue are then disregarded in step 312. Once the irrelevant user interactions are disregarded, the ITDS performs further comparison operations between the remaining captured interactions and the previously returned results of the relevant knowledgebase queries. Those remaining captured user interactions that match the previously returned results of the relevant knowledgebase queries are signified as such by the ITDS. The non-matching knowledgebase query results are then analyzed by the ITDS in step 314 to determine their applicability to resolving the user issue contained in the incident ticket. In one embodiment, an algorithm is implemented by the ITDS to rank the applicability of the non-matching knowledgebase query results to resolving the user issue contained in the incident ticket. In another embodiment, a predetermined confidence threshold value is applied to the algorithm to limit the number of non-matching knowledgebase query results that are presented to the user as a possible means of resolving the user issue contained in the incident ticket. In this embodiment, the non-matching knowledgebase query results that are above the predetermined confidence threshold are presented by the ITDS system to the user as a possible means of resolving the user issue contained in the incident ticket.

If it is determined in step 316 that the issue contained in the incident ticket is resolved, then the incident ticket is closed in step 328. If it is then determined in step 330 to resolve another issue, then the process is repeated beginning with step 304. Otherwise, issue resolution is ended in step 332. If it is determined in step 316 that the issue contained in the incident ticket is not resolved, then it is determined in step 318 whether to abandon the incident ticket. If it is determined that the incident ticket is to be abandoned, then the incident is abandoned in step 320. If it is then determined in step 330 to resolve another issue, then the process is repeated beginning with step 304. Otherwise, issue resolution is ended in step 332. If it is determined in step 318 that the incident ticket is not to be abandoned, then it is determined in step 322 whether to escalate the incident ticket to a helpdesk for human support in resolving the issue contained in the incident ticket. If it is determined in step 322 to not escalate the incident ticket to a helpdesk, then the process is repeated beginning with step 306.

Otherwise, the incident ticket is escalated to a helpdesk in step 324 for human support in resolving the issue contained in the incident ticket. In one embodiment, the ITDS may require the user to perform one or more recommended remedial actions before helpdesk contact information is provided allowing the user to escalate the incident ticket to a helpdesk operator. In another embodiment, the user places a telephone call to a helpdesk operator, which accepts the phone call and requests predetermined information to determine and confirm the user's identity and to locate their associated incident ticket. Once located, the incident ticket is retrieved from the incident ticket management system and is presented to the helpdesk operator. When presented, the incident ticket is populated with all relevant user interactions with the self-service portal, recommended remedial actions presented to the user, and the current resolution status of the user's issue. The helpdesk operator then uses the information contained in the escalated incident ticket to propose remedial actions in step 326 for the user to perform. It will be apparent to those of skill in the art that provision of this information on the incident ticket offers the advantage of reducing the amount of time required by the helpdesk operator to determine what previous efforts have been made to resolve the user's issue. Furthermore, it will be similarly appreciated that this time reduction enables more effective responses to the needs of the user and more cost-effective use of the helpdesk operator.

If it is determined in step 316 that the issue contained in the incident ticket is resolved, then the incident ticket is closed in step 328. If it is then determined in step 330 to resolve another issue, then the process is repeated beginning with step 304. Otherwise, issue resolution is ended in step 332. If it is determined in step 316 that the issue contained in the incident ticket is not resolved, then it is determined in step 318 whether to abandon the incident ticket. If it is determined in step 318 to not abandon the incident ticket, then the process is repeated beginning with step 322. If it is determined in step 318 that the incident ticket is to be abandoned, then the incident is abandoned in step 320. If it is then determined in step 330 to resolve another issue, then the process is repeated beginning with step 304. Otherwise, issue resolution is ended in step 332.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for reducing an amount of human interaction involved in resolution of incident tickets, comprising:
generating at least one incident ticket comprising at least one issue to be resolved;
capturing interactions of a user with a self-service portal;
comparing captured self-service portal interactions with the at least one issue to be resolved to determine which of the interactions are relevant to resolving the at least one issue;
analyzing relevant self-service portal interactions of the user to generate at least one remedial action for the user to perform;
escalating the at least one incident ticket for human resolution when the results of the at least one remedial action performed by the user does not resolve the at least one issue.

2. The method of claim 1, wherein the interactions with the self-service portal comprise using the self-service portal for accessing information contained in an issue resolution knowledgebase.

3. The method of claim 1, wherein the analyzing comprises determining relevance of the self-service portal interactions to the at least one issue to be resolved.

4. The method of claim 3, wherein the determining sets a relevance of the user's plurality of self-service interactions to a predetermined threshold.

5. The method of claim 1, wherein the results of the at least one remedial action resolves the at least one issue and the at least one incident ticket is closed.

6. The method of claim 1, wherein the at least one incident ticket comprises the analysis of the relevant self-service portal interactions of the user.

7. A system comprising:
a processor;
a data bus coupled to the processor; and
a computer-usable medium embodying computer program code, the computer-usable medium being coupled to the data bus, the computer program code reducing an amount of human interaction involved in resolution of incident tickets and comprising instructions executable by the processor and configured for:
generating at least one incident ticket comprising at least one issue to be resolved;
capturing interactions of a user with a self-service portal;
comparing captured self-service portal interactions with the at least one issue to be resolved to determine which of the interactions are relevant to resolving the at least one issue;
analyzing relevant self-service portal interactions of the user to generate at least one remedial action for the user to perform;
escalating the at least one incident ticket for human resolution when the results of the at least one remedial action performed by the user does not resolve the at least one issue.

8. The system of claim 7, wherein the interactions with the self-service portal comprise using the self-service portal for accessing information contained in an issue resolution knowledgebase.

9. The system of claim 7, wherein the analyzing comprises determining relevance of the self-service portal interactions to the at least one issue to be resolved.

10. The system of claim 9, wherein the determining sets a relevance of the user's plurality of self-service interactions to a predetermined threshold.

11. The system of claim 7, wherein the results of the at least one remedial action resolves the at least one issue and the at least one incident ticket is closed.

12. The system of claim 1, wherein the at least one incident ticket comprises the analysis of the relevant self-service portal interactions of the user.

13. A computer-usable medium embodying computer program code, the computer program code comprising computer executable instructions configured for:
generating at least one incident ticket comprising at least one issue to be resolved;
capturing interactions of a user with a self-service portal;
comparing captured self-service portal interactions with the at least one issue to be resolved to determine which of the interactions are relevant to resolving the at least one issue;
analyzing relevant self-service portal interactions of the user to generate at least one remedial action for the user to perform;
escalating the at least one incident ticket for human resolution when the results of the at least one remedial action performed by the user does not resolve the at least one issue.

14. The computer-usable medium of claim 13, wherein the interactions with the self-service portal comprise using the self-service portal for accessing information contained in an issue resolution knowledgebase.

15. The computer-usable medium of claim 13, wherein the analyzing comprises determining relevance of the self-service portal interactions to the at least one issue to be resolved.

16. The computer-usable medium of claim 15, wherein the determining sets a relevance of the user's plurality of self-service interactions to a predetermined threshold.

17. The computer usable medium of claim 13, wherein the results of the at least one remedial action resolves the at least one issue and the at least one incident ticket is closed.

18. The computer-usable medium of claim 13, wherein the at least one incident ticket comprises the analysis of the relevant self-service portal interactions of the user.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
